(19) United States
(12) Patent Application Publication
(10) Pub. No.: US 2008/0028082 A1
(43) Pub. Date: Jan. 31, 2008

(54) Sip message delivery program

(75) Inventor: Shingo Suzuki, Kawasaki (JP)

Correspondence Address: GREER, BURNS & CRAIN, 300 S WACKER DR, 25TH FLOOR, CHICAGO, IL, 60606, US

(73) Assignee: Fujitsu Limited, Kawasaki-shi (JP)

(21) Appl. No.: 11/821,606

(22) Filed: Jun. 25, 2007

(30) Foreign Application Priority Data
Jul. 27, 2006 (JP) 2006-205297

(51) Int. Cl. G06F 15/16

(52) U.S. Cl. 709/228

(57) ABSTRACT

A computer on which an SIP message delivery program is running stores records for respective entities of an SIP message that contains location information into a table in a storage device. Each record links virtual host identifying information to identify a virtual host that receives an SIP message only when the entities contain predetermined location information with the predetermined location information that is a content of the receipt condition. The computer receives an SIP message from an SIP server on a network, and searches the table for a record whose receipt condition in an entity matches location information in the corresponding entity in the received SIP message, for each of entities in a predetermined order. When a record is detected, the computer delivers the received SIP message to the virtual host that is distinguished by the virtual host identifying information included in the detected record.

### BACKGROUND OF THE INVENTION

The present invention relates to an SIP (Session Initiation Protocol) message delivery program that makes a computer function as a device to deliver an SIP message to an SIP server.

Generally, a host means a computer that has a function to provide service and performance to other computers on a network. In a normal operation, one computer functions as one host. However, a technique to operate a plurality of hosts on one computer is developed in recent years. This technique is called virtual hosting. According to the virtual hosting, the functions of hosts can be increased as virtual hosts without increasing the number of physical computers.

A plurality of virtual hosts implemented on one computer by the virtual hosting provide the same kinds of functions and communicate with other computers on a network according to the same communication protocol using the same IP (Internet Protocol) address. Therefore, when the data has been sent from other computers on the network, it is necessary to deliver the data to the suitable virtual host in the virtual hosting.

When each virtual host is an SIP server, each virtual host receives SIP messages from other SIP servers and SIP clients on the network. The SIP message consists of a starting line, a header, and a body as shown in FIG. 4. In the conventional virtual hosting, when a plurality of SIP servers are implemented on one computer as virtual hosts, the function to distinguish destination addresses is included in an interface engine that receives an SIP message. That is, the interface engine distinguishes the virtual host that should receive the SIP message based on the contents of the predetermined entity in the SIP message, and it delivers the SIP message to the suitable virtual host distinguished.

For example, assuming that four SIP servers are implemented on one computer as virtual hosts, the interface engine delivers the SIP message to one of the four servers based on the contents of entity in the SIP message. When the value of the “Route” header field of the SIP message is the domain name “sss.co.jp”, the SIP message is delivered to the first SIP server. When the URI (Uniform Resource Identifier) in the starting line of the SIP message includes “sip:bbb@ttt.co.jp”, the SIP message is delivered to the second SIP server. When the value of the “From” header field of the SIP message is the URI “sip:ccc@uuu.co.jp”, the SIP message is delivered to the third SIP server. And when the value of the “To” header field of the SIP message is the URI “sip:ddd@vvv.co.jp”, the SIP message is delivered to the fourth SIP server.

The interface engine manages the receipt conditions of the SIP message for the respective SIP servers using a table. The interface engine searches the table to distinguish the suitable SIP server whenever it receives the SIP message.

For example, JP2006-099207A discloses this kind of SIP-AP server system. Particularly, the paragraph 0038 teaches that a mapping section detects a corresponding SIP-AP execution server and a corresponding handler based on an SIP message received by the handler and an SIP message supplied from the SIP-AP execution server.

However, if an SIP message directed to any SIP server includes some receipt conditions that are defined in the table by the conventional interface engine, a plurality of virtual hosts are extracted as targets to which the SIP message should be delivered, which causes a problem. That is, the SIP message is delivered to a plurality of virtual hosts.

In the example mentioned above, when the SIP message includes “sss.co.jp” in the “Route” header field and includes “sip:ccc@uuu.co.jp” in the “From” header field, the conventional interface engine delivers the SIP message to the first and third SIP servers.

### SUMMARY OF THE INVENTION

The present invention is achieved to solve the above mentioned problem of the prior art and an object thereof is to deliver an SIP message that is sent to any SIP server to one suitable SIP server in a computer on which a plurality of SIP servers are implemented as virtual hosts.

The SIP message delivery program of the present invention is a program to deliver an SIP message that is sent to any of virtual hosts as SIP servers to a suitable virtual host. The program makes a computer execute functions including: a storing function for storing records for respective entities of an SIP message that can contain location information into a table in a storage device, wherein each record links virtual host identifying information to identify a virtual host that receives an SIP message only when the entities contain predetermined location information with the predetermined location information that is a content of the receipt condition; a receiving function for receiving an SIP message from an SIP server on a network; a search function for searching the table for a record whose receipt condition in an entity matches location information in the corresponding entity in the SIP message received by the receiving function, for each of entities in a predetermined order;land a delivery function for delivering, when a record is detected by the search function by executing the search process for each of the entities in order, the SIP message received by the receiving function to the virtual host that is distinguished by the virtual host identifying information included in the detected record.

With this configuration, the computer on which the SIP message delivery program is running can detect one of receipt conditions in advance by searching the entities including location information in the SIP message one by one, even when the SIP message that is received from any SIP server on the network includes some receipt conditions for the virtual hosts. Therefore, if a priority order of the entities that are targets of the search process is appropriately established, the only one suitable virtual host is determined based on the priority order, and an SIP message can be delivered to the only one virtual host.

According to the SIP message delivery program of the present invention, each search process is executed to not only an SIP message that is received from an SIP server on a network through the communication device, but also an SIP message received from any virtual host. In the latter case, when a virtual host sends an SIP message to another virtual host, the SIP message is transmitted so as to fold back inside the computer without leaking the SIP message to the network through the communication device.

In the SIP message delivery program of the present invention, if each entity of an SIP message contains location information, the entity is sufficient to be a target of the search process. For example, available entities as target of the search process are: a starting line that contains location information to specify a location of designated address of a method, a “Route” header field that contains location information to specify a location of a relay device, a “From” header field that contains location information to specify a location of a transmitter, and a “To” header field that contains location information to specify a location of a receiver.

As described above, according to the present invention, an SIP message that is sent to any SIP server can be delivered to one suitable SIP server in a computer on which a plurality of SIP servers are implemented as virtual hosts.

### DESCRIPTION OF THE ACCOMPANYING DRAWINGS

FIG. 1 is a block diagram of a host device of an embodiment that executes the SIP message delivery program of the present invention,

FIG. 2 shows an example of a data structure of a distinguishment table included in the host device of FIG. 1,

FIG. 3 is a flowchart showing a host distinguishment process that is executed by the host device of FIG. 1, and FIG. 4 shows an example of an SIP message.

### DESCRIPTION OF THE PREFERRED EMBODIMENTS

There will now be described an embodiment of the present invention with reference to the accompanying drawings.

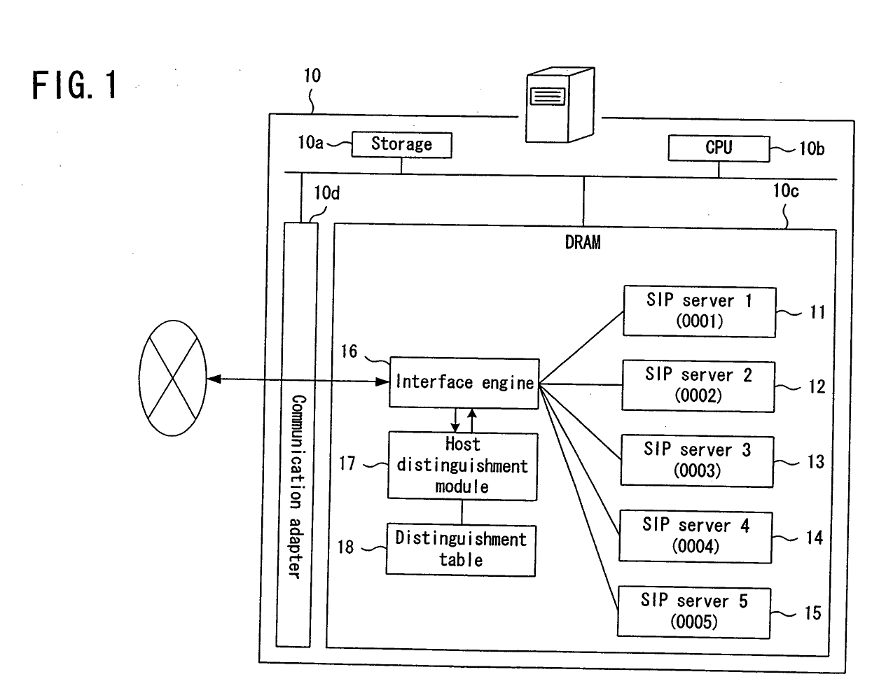

FIG. 1 is a block diagram of a host device 10 of the embodiment.

The host device 10 is a computer on which five SIP (Session Initiation Protocol) servers are implemented as virtual hosts. It is well known that the computer contains storage 10a, a CPU (Central Processing Unit) 10b, a DRAM (Dynamic Random Access Memory) 10c, a communication adapter 10d, and the like. The storage 10a is a memory device that stores various kinds of programs and data. The CPU 10b is a control device that executes various kinds of processes according to the programs stored in the storage 10a. The DRAM 10c is a memory device on which a workspace is developed when the CPU 10b executes various kinds of processes. The communication adapter 10d is a communication device that exchanges data with computers or relay devices on a network.

The storage 10a of the host device 10 stores basic software that provides many pieces of application software (not shown) with basic functions such as a data input/output management by the communication adapter 10d and a memory are a management in the storage 10a and the DRAM 10c. Further, the storage 10a stores a software group to implement five SIP servers 11 through 15. Further, the storage 10a stores a software group to implement an interface engine 16 described below. Still further, the storage 10a stores a software group to implement a host distinguishment module 17 concerning the present invention, and a distinguishment table 18 used by the host distinguishment module 17.

Each of the SIP servers 11 through 15 contains at least a proxy server, a redirection server, and a register server (not shown) to implement a function as an SIP server. Among these, the proxy server has a function that specifies a location of a session partner's user agent as a substitute of a user agent (an SIP client), and calls a session partner's user agent server. The redirection server has a function that acquires an address of the session partner from a location server (not shown) to notify the address to the user agent that requests the session. The register server has a function that makes a location server (not shown) register, change, and delete information about the user agent based on the request from the user agent (SIP client). Since the proxy server, the redirection server and the register server are well known, details thereof are not described here. Each of the SIP servers 11 through 15 performs signaling between the user agents by exchanging SIP messages with the user agents (the SIP clients) according to the SIP and manages inputting and cutting of sessions between the user agents.

The interface engine 16 receives SIP messages from the SIP server or the user agents on the network, and sends SIP messages to the SIP server or the user agent on the network. Receiving an SIP message from the SIP server or the user agent on the network or from any of the SIP servers 11 through 15, the interface engine 16 generates a process of the host distinguishment module 17 described below in order to judge whether the SIP message is directed to one of the SIP servers 11 through 15. And this interface engine 16 transmits the SIP message to the SIP server or the user agent on the network according to the SIP, when the process judged that the SIP message is not directed to any of the SIP servers 11 through 15. On the contrary, when the process judged that the SIP message is directed to one of the SIP servers 11 through 15, the interface engine 16 makes a thread that has a function to deliver the SIP message to the SIP server of destination and makes the thread deliver the SIP massage concerned to the SIP server.

Therefore, the interface engine 16 corresponds to the receiving function mentioned above.

The host distinguishment module 17 has a function to distinguish the destination of the SIP message that is received by the interface engine 16 in response to an instruction from the interface engine 16. The contents of the process of the host distinguishment module 17 (the CPU 10b that executes this module) will be mentioned below.

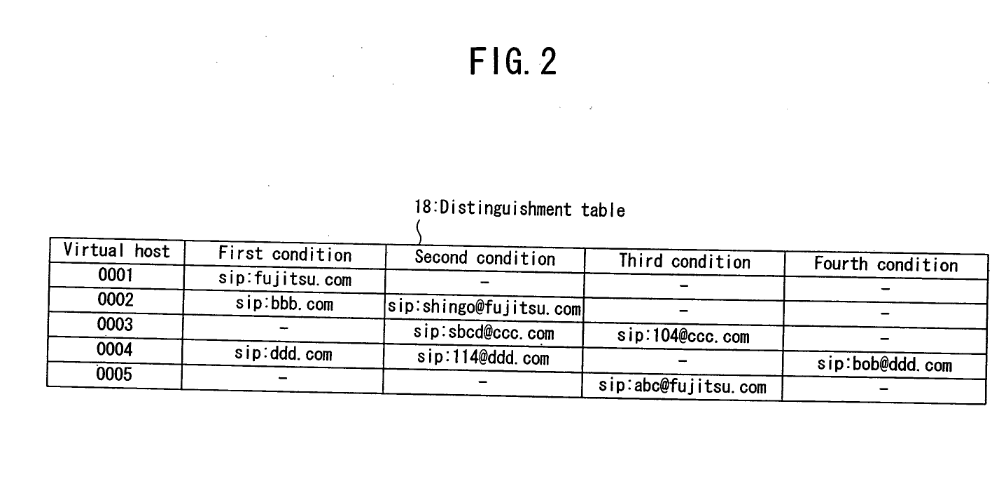

The distinguishment table 18 is used when the host distinguishment module 17 distinguishes the destination of the SIP message. FIG. 2 shows an example of the data structure of the distinguishment table 18. As shown in FIG. 2, the distinguishment table 18 has records as many as the SIP servers 11 through 15. Each record has fields of a “virtual host”, a “first condition”, a “second condition”, a “third condition”, and a “fourth condition”. The “virtual host” field stores virtual host identification information that is used to identify an individual SIP server from the SIP servers 11 through 15 that are virtual hosts. Each of the “first condition” field, the “second condition” field, the “third condition” field, and the “fourth condition” field stores location information in a form of a URI (Uniform Resource Identifier) as a condition of the SIP message that will be received by the SIP servers 11 through 15, or stores nothing.

As described below, if a URI defined in the “first condition” field is included in a “Route” header field (see FIG. 4) of the SIP message that is received by the interface engine 16, the SIP servers 11 through 15 corresponding to the record containing the URI become receipt destinations of the SIP message. When the “first condition” field is blank, the SIP servers 11 through 15 do not become the receipt destinations of the SIP message regardless of the value of the “Route” header field. When a URI defined in the “second condition” field is included in the starting line (see FIG. 4) of the SIP message as in the case of the “first condition” field, the corresponding SIP servers 11 through 15 become receipt destinations of the SIP message. If a URI that is defined in the “third condition” field is included in the “To” header field (see FIG. 4) of the SIP message, the corresponding SIP servers 11 through 15 become receipt destinations of the SIP message. If a URI that is defined in the “fourth condition” field is included in the “From” header field (see FIG. 4) of the SIP message, the corresponding SIP servers 11 through 15 become receipt destinations of the SIP message.

Therefore, the host device 10 that stores this distinguishment table 18 in the storage 10a has the above-mentioned storing function.

Next, contents of a process executed by the host distinguishment module 17 in the host device 10 will be described.

As mentioned above, the host distinguishment module 17 starts when the interface engine 16 receives the SIP message from either an SIP server or a user agent on the network, or one of the SIP servers 11 through 15.

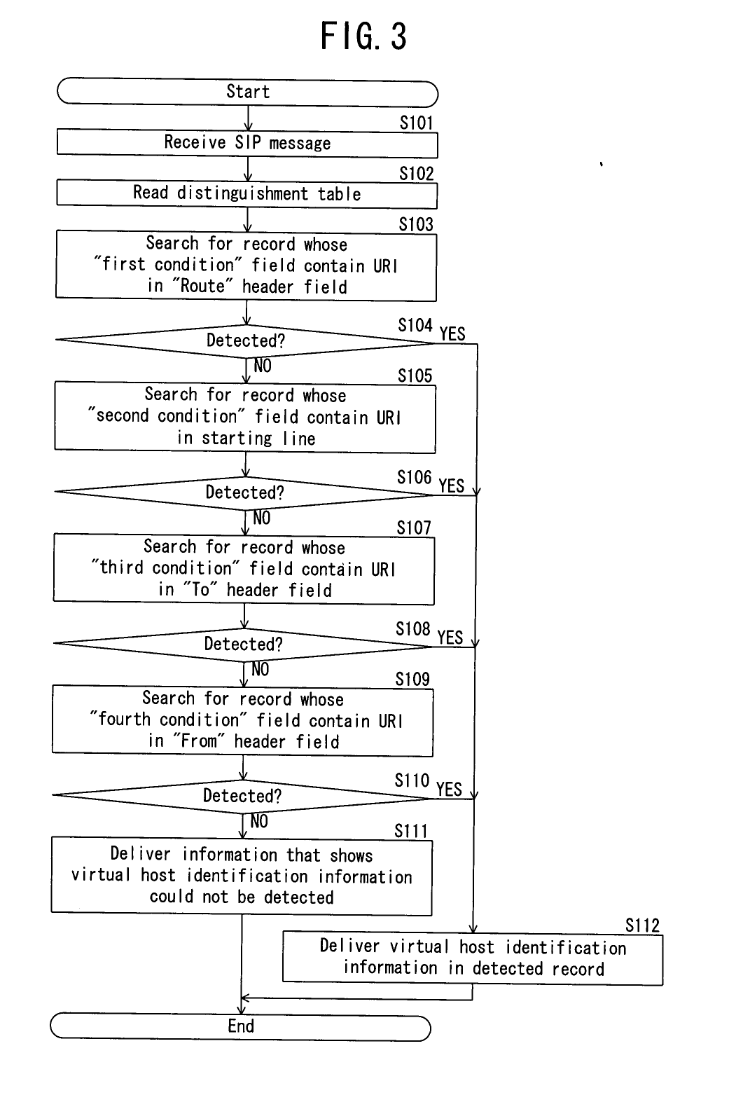

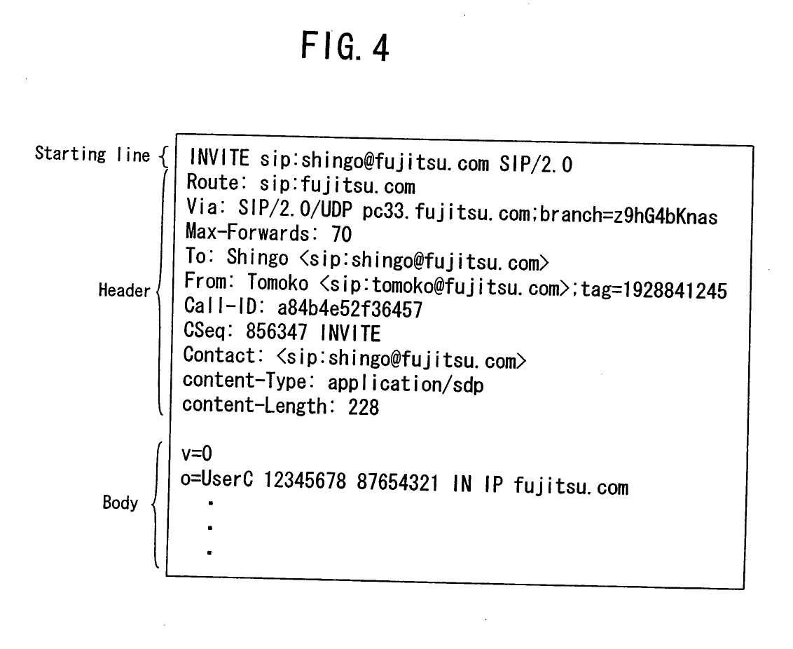

FIG. 3 is a flowchart showing contents of the host distinguishment process.

In a first step S101 of the host distinguishment process, the host distinguishment module 17 (the CPU 10b that executes this module) receives the SIP message that is received by the interface engine 16 from the interface engine 16.

In the next step S102, the host distinguishment module 17 reads the distinguishment table 18 shown in FIG. 2 from the storage 10a.

In the next step S103, the host distinguishment module 17 reads the URI from the “Route” header field of the SIP message received from interface engine 16 in step S101, and searches the distinguishment table 18 of FIG. 2 for a record whose “first condition” field contains the read URI.

In the next step S104, the host distinguishment module 17 judges whether a record whose “first condition” field contains the URI in the “Route” header field of the SIP message has been detected. Then, the host distinguishment module 17 branches the process from step S104 to step S112, when the record concerned has been detected. On the other hand, when the record concerned has not been detected, the module advances the process to step S105.

In step S105, the host distinguishment module 17 reads the URI from the starting line of the SIP message received from the interface engine 16 in step S101, and searches the distinguishment table 18 of FIG. 2 for a record whose “second condition” field contains the read URI.

At the next step S106, the host distinguishment module 17 judges whether a record whose “second condition” field contains the URI in the starting line of the SIP message has been detected. Then, the host distinguishment module 17 branches the process from step S106 to step S112, when the record concerned has been detected. On the other hand, when the record concerned has not been detected, the module advances the process to step S107.

At the next step S107, the host distinguishment module 17 reads the URI from the “To” header field of the SIP message received from the interface engine 16 in step S101, and searches the distinguishment table 18 of FIG. 2 for a record whose “third condition” field contains the read URI.

At the next step S108, the host distinguishment module 17 judges whether a record whose “third condition” field contains the URI in the “To” header field of the SIP message has been detected. Then, the host distinguishment module 17 branches the process from step S108 to step S112, when the record concerned has been detected. On the other hand, when the record concerned has not been detected, the module advances the process to step S109.

In the next step S109, the host distinguishment module 17 URI reads the URI from the “From” header field of the SIP message received from the interface engine 16 in step S101, and searches the distinguishment table 18 of FIG. 2 for a record whose “fourth condition” field contains the read URI.

In the next step S110, the host distinguishment module 17 judges whether the record whose “fourth condition” field contains the URI in the “From” header field has been detected. Then, the host distinguishment module 17 branches the process from step S110 to step S112, when the record concerned has been detected. On the other hand, when the record concerned has not been detected, the module advances the process to step S111.

In step S111, since the record that contains the virtual host identification information could not be detected in the distinguishment table 18 of FIG. 2, the host distinguishment module 17 delivers the information that shows the virtual host identification information could not be detected to the interface engine 16 as a return value. Then, the host distinguishment module 17 finishes the host distinguishment process shown in FIG. 3.

On the other hand, in step S112, since the record that contains the virtual host identification information could be detected in the distinguishment table 18 of FIG. 2, the host distinguishment module 17 delivers the virtual host identification information included in the record to the interface engine 16 as a return value. Then, the host distinguishment module 17 finishes the host distinguishment process shown in FIG. 3.

Therefore, the CPU 10b that executes step S103, S105, S107, and S109 corresponds to the search function mentioned above, and the CPU 10b that executes steps S111 and S112 corresponds to the delivery function mentioned above.

Receiving information showing that the virtual host identification information is not detected from the host distinguishment module 17, the interface engine 16 returns the SIP message with no destination information to the transmitter according to the SIP message. Further, receiving the virtual host identification information from the host distinguishment module 17, the interface engine 16 makes a thread of the module that delivers the SIP message to the virtual host (SIP server), and delivers the virtual host identification information and the SIP message to the thread. The thread delivers the SIP message to the virtual host (SIP server) that is specified by the virtual host identification information received from the interface engine 16.

Next, the operations and effects of the host device 10 of the embodiment will be described.

For example, assuming that the interface engine 16 of the host device 10 of this embodiment receives an SIP message as shown in FIG. 4 from the SIP server on the network, the “Route” header field of the SIP message shown in FIG. 4 includes the same URI (sip:fujitsu.com) as the value in the “first condition” field of the record of the SIP server 11 in the distinguishment table 18 of FIG. 2, and its starting line includes the same URI (sip:shingo@fujitsu.com) as the value in the “second condition” field of the record of the SIP server 12 in the distinguishment table 18 of FIG. 2.

Receiving such an SIP message, the interface engine 16 generates the process of the host distinguishment module 17. The host distinguishment module 17 searches the respective entities in the SIP message using the URI in the “Route” header field as a search key for a record of which “first condition” field includes the same URI (step S103). Since a record of the SIP server 11 is detected as a result of the search, the host distinguishment module 17 delivers the virtual host identification information (0001) of the SIP server 11 to the interface engine 16 (step S104; YES, sep S112).

At the time, although the starting line of the SIP message includes the same URI (sip:shingo@fujitsu.com) as the value of the “second condition” field of the record of the SIP server 12 in the distinguishment table 18 of FIG. 2, the search using the URI in the starting line as a search key (step S105) is not executed (step S104; YES). Therefore, the virtual host identification information (0002) of the SIP server 12 is not delivered to the interface engine 16 as a return value. As a result, the SIP message is certainly passed to one virtual host (SIP server). Thus, according to the host device 10 of the embodiment, even if the SIP message directed to any of the SIP servers 11 through 15 as virtual hosts contains some receipt conditions for some of the SIP severs 11 through 15, only one virtual host that should receives the SIP message can be extracted, and the SIP message is delivered to the extracted virtual host.

Further, according to the host device 10 of the embodiment, even when any of the SIP servers 11 through 15 as the virtual hosts sends an SIP message, the interface engine 16 generates a process of the host distinguishment module 17 with respect to the SIP message in order to execute the host distinguishment process of FIG. 3.

As a result, when an SIP message is transmitted inside the host device 10, that is, when the SIP message is sent from one of the SIP servers 11 through 15 to another of the SIP servers 11 through 15, since the interface engine 16 is notified of virtual host identification information that shows an appropriate destination of the SIP message from the host distinguishment module 17, the SIP message is transmitted to the SIP server other than the transmitter by folding back inside the computer, which can avoid a leak of a message to the network through the communication device.

What is claimed is:

1. An SIP message delivery program to deliver an SIP message that is sent to any of virtual hosts as SIP servers to a suitable virtual host, said program making a computer execute functions comprising:
a storing function for storing records for respective entities of an SIP message that can contain location information into a table in a storage device, wherein each record links virtual host identifying information to identify a virtual host that receives an SIP message only when the entities contain predetermined location information with the predetermined location information that is a content of the receipt condition;
a receiving function for receiving an SIP message from an SIP server on a network;
a search function for searching said table for a record whose receipt condition in an entity matches location information in the corresponding entity in the SIP message received by the receiving function, for each of entities in a predetermined order; and
a delivery function for delivering, when a record is detected by the search function by executing the search process for each of the entities in order, the SIP message received by the receiving function to the virtual host that is distinguished by the virtual host identifying information included in said detected record.

2. The SIP message delivery program according to claim 1, wherein said receiving function receives an SIP message from any of said virtual hosts.

3. The SIP message delivery program according to claim 1, wherein said delivery function delivers information showing the SIP message received by the receiving function cannot be accepted by any virtual hosts, when no record is detected while the search function executes the search process for each of the entities in order.

4. The SIP message delivery program according to claim 1, wherein said storing function stores a record that links virtual host identification information with a receipt condition into a table in said storage device with respect to said entities in said SIP message, and wherein said entities includes a starting line, a field that stores location information to specify a location of a relay device, a field that stores location information to specify the location of a transmitter, and a field that stores location information to specify a location of a receiver.

5. The SIP message delivery program according to claim 4, wherein said search function executes said search processes for the field that stores location information to specify a location of a relay device, the starting line, the field that stores location information to specify a location of a receiver, and the field that stores location information to specify a location of a transmitter, in this order.

6. A computer readable medium that stores an SIP message delivery program to deliver an SIP message that is sent to any of virtual hosts as SIP servers to a suitable virtual host, said program making a computer execute functions comprising:
a storing function for storing records for respective entities of an SIP message that can contain location information into a table in a storage device, wherein each record links virtual host identifying information to identify a virtual host that receives an SIP message only when the entities contain predetermined location information with the predetermined location information that is a content of the receipt condition;
a receiving function for receiving an SIP message from an SIP server on a network;
a search function for searching said table for a record whose receipt condition in an entity matches location information in the corresponding entity in the SIP message received by the receiving function, for each of entities in a predetermined order; and
a delivery function for delivering, when a record is detected by the search function by executing the search process for each of the entities in order, the SIP message received by the receiving function to the virtual host that is distinguished by the virtual host identifying information included in said detected record.

7. The computer readable medium according to claim 6, wherein said receiving function receives an SIP message from any of said virtual hosts.

8. The computer readable medium according to claim 6, wherein said delivery function delivers information showing the SIP message received by the receiving function cannot be accepted by any virtual hosts, when no record is detected while the search function executes the search process for each of the entities in order.

9. The computer readable medium according to claim 6, wherein said storing function stores a record that links virtual host identification information with a receipt condition into a table in said storage device with respect to said entities in said SIP message, and wherein said entities includes a starting line, a field that stores location information to specify a location of a relay device, a field that stores location information to specify the location of a transmitter, and a field that stores location information to specify a location of a receiver.

10. The computer readable medium according to claim 6, wherein said search function executes said search processes for the field that stores location information to specify a location of a relay device, the starting line, the field that stores location information to specify a location of a receiver, and the field that stores location information to specify a location of a transmitter, in this order.

11. An SIP message delivery device to deliver an SIP message that is sent to any of virtual hosts as SIP servers to a suitable virtual host, said device comprising:
a storing section for storing records for respective entities of an SIP message that can contain location information into a table in a storage device, wherein each record links virtual host identifying information to identify a virtual host that receives an SIP message only when the entities contain predetermined location information with the predetermined location information that is a content of the receipt condition;
a receiving section for receiving an SIP message from an SIP server on a network;
a search section for searching said table for a record whose receipt condition in an entity matches location information in the corresponding entity in the SIP message received by the receiving section, for each of entities in a predetermined order; and
a delivery section for delivering, when a record is detected by the search section by executing the search process for each of the entities in order, the SIP message received by the receiving section to the virtual host that is distinguished by the virtual host identifying information included in said detected record.

12. The SIP message delivery device according to claim 11, wherein said receiving section receives an SIP message from any of said virtual hosts.

13. The SIP message delivery device according to claim 11, wherein said delivery section delivers information showing the SIP message received by the receiving section cannot be accepted by any virtual hosts, when no record is detected while the search section executes the search process for each of the entities in order.

14. The SIP message delivery device according to claim 11, wherein said storing section stores a record that links virtual host identification information with a receipt condition into a table in said storage device with respect to said entities in said SIP message, and wherein said entities includes a starting line, a field that stores location information to specify a location of a relay device, a field that stores location information to specify the location of a transmitter, and a field that stores location information to specify a location of a receiver.

15. The SIP message delivery device according to claim 11, wherein said search section executes said search processes for the field that stores location information to specify a location of a relay device, the starting line, the field that stores location information to specify a location of a receiver, and the field that stores location information to specify a location of a transmitter, in this order.

16. An SIP message delivery method to deliver an SIP message that is sent to any of virtual hosts as SIP servers to a suitable virtual host, said method making a computer execute procedures comprising:
a storing procedure for storing records for respective entities of an SIP message that can contain location information into a table in a storage device, wherein each record links virtual host identifying information to identify a virtual host that receives an SIP message only when the entities contain predetermined location information with the predetermined location information that is a content of the receipt condition;
a receiving procedure for receiving an SIP message from an SIP server on a network;
a search procedure for searching said table for a record whose receipt condition in an entity matches location information in the corresponding entity in the SIP message received by the receiving procedure, for each of entities in a predetermined order; and
a delivery procedure for delivering, when a record is detected by the search procedure by executing the search process for each of the entities in order, the SIP message received by the receiving procedure to the virtual host that is distinguished by the virtual host identifying information included in said detected record.

17. The SIP message delivery method according to claim 16, wherein said receiving procedure receives an SIP message from any of said virtual hosts.

18. The SIP message delivery method according to claim 16, wherein said delivery procedure delivers information showing the SIP message received by the receiving procedure cannot be accepted by any virtual hosts, when no record is detected while the search procedure executes the search process for each of the entities in order.

19. The SIP message delivery method according to claim 16, wherein said storing procedure stores a record that links virtual host identification information with a receipt condition into a table in said storage device with respect to said entities in said SIP message, and wherein said entities includes a starting line, a field that stores location information to specify a location of a relay device, a field that stores location information to specify the location of a transmitter, and a field that stores location information to specify a location of a receiver.

20. The SIP message delivery method according to claim 16, wherein said search procedure executes said search processes for the field that stores location information to specify a location of a relay device, the starting line, the field that stores location information to specify a location of a receiver, and the field that stores location information to specify a location of a transmitter, in this order.
